(19) United States
(12) Patent Application Publication
(10) Pub. No.: US 2011/0217096 A1
(43) Pub. Date: Sep. 8, 2011

(54) FIXING DEVICE

(75) Inventors: Kazuhiko KIKUCHI, Kanagawa (JP); Satoshi Kinouchi, Tokyo (JP); Shuji Yokoyama, Shizuoka (JP); Hiroyuki Kunugi, Shizuoka (JP); Hiroshi Nakayama, Shizuoka (JP); Yoshiaki Okano, Shizuoka (JP); Setsuo Takada, Shizuoka (JP); Toshihiro Sone, Kanagawa (JP)

(73) Assignees: Kabushiki Kaisha Toshiba, Tokyo (JP); Toshiba Tec Kabushiki Kaisha, Tokyo (JP)

(21) Appl. No.: 13/033,556

(22) Filed: Feb. 23, 2011

Related U.S. Application Data
(60) Provisional application No. 61/310,171, filed on Mar. 3, 2010.

(51) Int. Cl. G03G 15/20

(52) U.S. Cl. 399/329

(57) ABSTRACT

A fixing device includes a fixing belt comprising a first metal heat generating layer, a pressurizing unit which faces an outer circumference of the fixing belt, an induced current generating coil located within a hollow part of the fixing belt, a nip forming member which pressurizes the fixing belt to the pressurizing unit, and an auxiliary heat generating member located in a periphery of the fixing belt and comprising a second metal heat generating layer.

### CROSS-REFERENCE TO RELATED APPLICATION

This application is based upon and claims the benefit of priority from Provisional U.S. Application 61/310171 filed on Mar. 3, 2010, the entire contents of which are incorporated herein by reference.

### FIELD

Embodiments described herein relate generally to a fixing device which is used in an image forming apparatus and realizes quick temperature rise and prevents occurrence of temperature variance.

### BACKGROUND

As a fixing device used in an image forming apparatus such as a copier or printer, there is a device which uses a fixing belt having a thin heat generating layer and a small heat capacity in order to save energy and realize quick temperature rise. The fixing device using the fixing belt may use a pressurizing pad as a nip forming member between the fixing belt and a pressurizing unit.

Since the fixing belt has a small heat capacity, the fixing belt has a significant temperature fall due to the passage of a sheet at the time of fixing. Moreover, the heat capacity of the pressurizing pad is not small. Therefore, in the fixing device, the quantity of heat provided for the fixing belt may not be enough to compensate for the quantity of heat taken by the pressurizing pad. The fixing belt may have temperature variance in a belt cycle because of the temperature fall due to the contact with the pressurizing pad. For a fixed image on the sheet, deterioration in image quality such as gloss variance may occur because of the temperature variance of the fixing belt.

### BRIEF DESCRIPTION OF THE DRAWINGS

FIG. 1 shows a schematic configuration of an MFP equipped with a fixing unit according to a first embodiment.

FIG. 2 shows a schematic configuration of the fixing unit as viewed from a lateral side, and a schematic view of a control block focusing on the fixing unit according to the first embodiment.

FIG. 3 is a schematic explanatory view of an auxiliary heat generating member and an IH coil in the fixing unit according to the first embodiment.

FIG. 4 is a schematic explanatory view showing temperature detection parts on a fixing belt according to the first embodiment.

FIG. 5 is a schematic explanatory view showing the layered configurations of the fixing belt and the auxiliary heat generating member according to the first embodiment.

FIG. 6 is a schematic explanatory view showing the structure of a pressurizing pad according to the first embodiment.

FIG. 7 is a table showing material properties of the pressurizing pad according to the first embodiment.

FIG. 8 is a schematic explanatory view showing another exemplary layered configuration of a first auxiliary heat generating part.

FIG. 9 shows a schematic configuration of a fixing unit according to a second embodiment, as viewed from a lateral side.

FIG. 10 is a schematic explanatory view showing the layered configuration of a third auxiliary heat generating part in the fixing unit according to the second embodiment.

### DETAILED DESCRIPTION

According to an embodiment, a fixing device includes a fixing belt comprising a first metal heat generating layer, a pressurizing unit which faces an outer circumference of the fixing belt, an induced current generating coil located within a hollow part of the fixing belt, a nip forming member which pressurizes the fixing belt to the pressurizing unit, and an auxiliary heat generating member located in a periphery of the fixing belt and comprising a second metal heat generating layer.

Hereinafter, embodiments will be described.

### First Embodiment

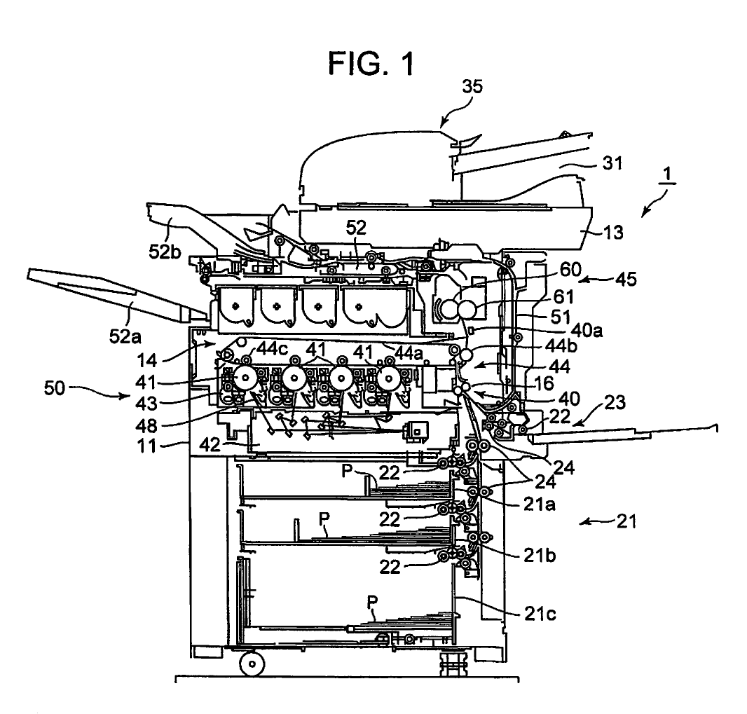

FIG. 1 shows a schematic configuration of a multi-functional peripheral (hereinafter simply referred to as MFP) 1 as an image forming apparatus equipped with a fixing device according to a first embodiment. The MFP 1 has a scanner unit 13 which reads an image, a printer unit 14 as an image forming unit, a paper supply unit 21 which supplies a sheet P as a recording medium, and a paper discharge unit 52 including a first tray 52a and a second tray 52b on which the sheet P discharged from the printer unit 14 is stacked. The MFP 1 has a manual paper supply unit 23 on a lateral part of a casing 11. The MFP 1 has a carrying mechanism 40 for the sheet P in a section extending from the paper supply unit 21 or the manual paper supply unit 23 to the paper discharge unit 52 via the printer unit 14.

The scanner unit 13 scans an original document supplied by an automatic document feeder (ADF) 35 and thus takes in image information. After the reading of the image information by the scanner unit 13 is finished, the ADF 35 discharges the document to a document discharge unit 31.

The printer unit 14 forms, on the sheet P, an image corresponding to input image information or the read image information from the scanner unit 13. The printer unit 14 has four image forming stations 50 for yellow (Y), magenta (M), cyan (C) and black (K), an exposure device 42, and a transfer unit 44 which transfers toner images formed by the image forming stations 50 to the sheet P of an predetermined size. The printer unit 14 has a fixing unit 45 as a fixing device which fixes the toner images to the sheet P.

The four image forming stations 50 have the same structure including a photoconductive drum 41, a charger 48 which uniformly charges the photoconductive drum 41, and a developing device 43 which develops an electrostatic latent image formed on the photoconductive drum 41 by irradiation with exposure light from the exposure device 42 after the charging and thus forms a toner image. The transfer unit 44 has an intermediate transfer belt 44a, a primary transfer roller 44c, and a secondary transfer roller 44b.

The paper supply unit 21 has an upper paper supply cassette 21a, a lower paper supply cassette 21b, and a large-capacity cassette 21c. The carrying mechanism 40 has a carrying roller 24 and a registration roller 16 which supply the sheet P taken out of the paper supply unit 21 or the manual paper supply unit 23 by a pickup roller 22, to the transfer unit 44. The carrying mechanism 40 carries the sheet P having a fixed toner image via the transfer unit 44 and the fixing unit 45, to the paper discharge unit 52 or a circulating path 51. The paper discharge unit 52 discharges the sheet P to the first tray 52a or the second tray 52b, or reverses the sheet P in the direction of the circulating path 51. The circulating path 51 guides the sheet P to the transfer unit 44 again. The carrying mechanism 40 has a sheet sensor 40a which detects the sheet P between the transfer unit 44 and the fixing unit 45.

In the MFP 1, as image formation starts, the photoconductive drum 41 is charged by the charger 48. Then the photoconductive drum 41 is irradiated with exposure light by the exposure device 42. An electrostatic latent image corresponding to the exposure light is thus formed on the photoconductive drum 41. The developing device 43 provides a toner to the electrostatic latent image on the photoconductive drum 41 and thus develops the electrostatic latent image to be visible. The transfer unit 44 transfers the toner image, formed by making the electrostatic latent image visible on the photoconductive drum 41, to the sheet P via the intermediate transfer belt 44a.

The sheet P supplied from either the paper supply unit 21 or the manual paper supply unit 23 reaches, via the carrying mechanism 40, a nip between the intermediate transfer belt 44a and the secondary transfer roller 44b synchronously with the toner image that is primary-transferred onto the intermediate transfer belt 44a. The secondary transfer roller 44b performs secondary transfer of the toner image on the intermediate transfer belt 44a to the sheet P passing through the nip between the intermediate transfer belt 44a and the secondary transfer roller 44b. The fixing unit 45 fixes the toner image to the sheet P. The paper discharge unit 52 discharges the sheet P after the toner image is fixed thereto, to the first tray 52a or the second tray 52b. The circulating path 51 guides the sheet P after the toner image is fixed thereto, again in the direction of the secondary transfer roller 44b of the transfer unit 44.

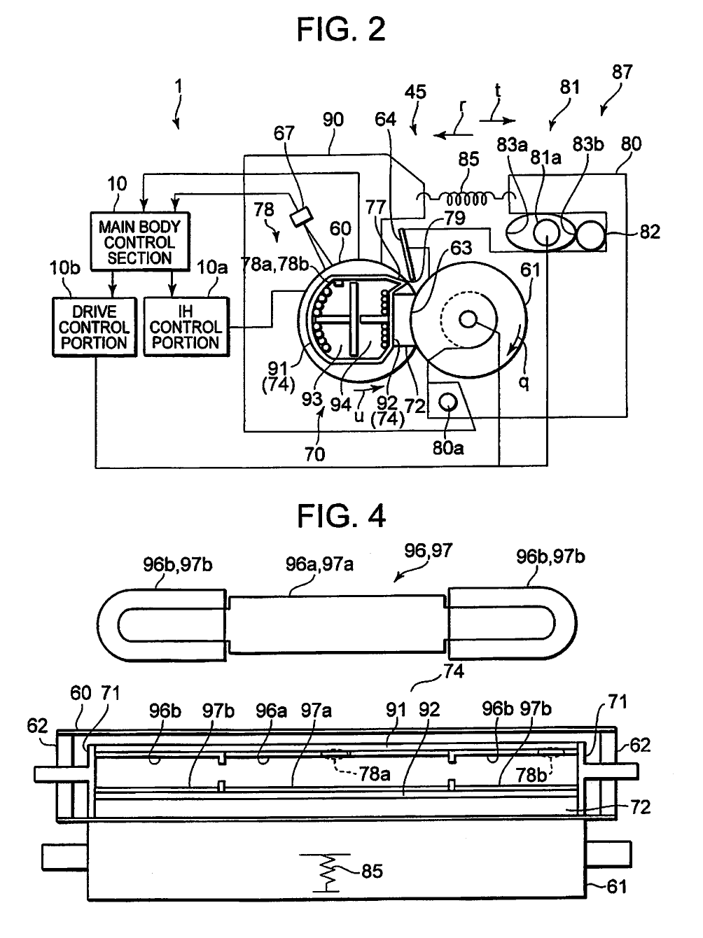

Next, the fixing unit 45 will be described in detail. As shown in FIG. 2 to FIG. 8, the fixing unit 45 has a fixing belt 60, a press roller 61 as a pressurizing unit, an induced current generating coil (hereinafter simply referred to as IH coil) 70, a pressurizing pad 72 as a nip forming member, an auxiliary heat generating member 74, and a non-contact thermopile-type infrared temperature sensor 67. The fixing unit 45 has a separation blade 64 as a separation member to the sheet P discharging side from a nip 63, on the circumference of the fixing belt 60.

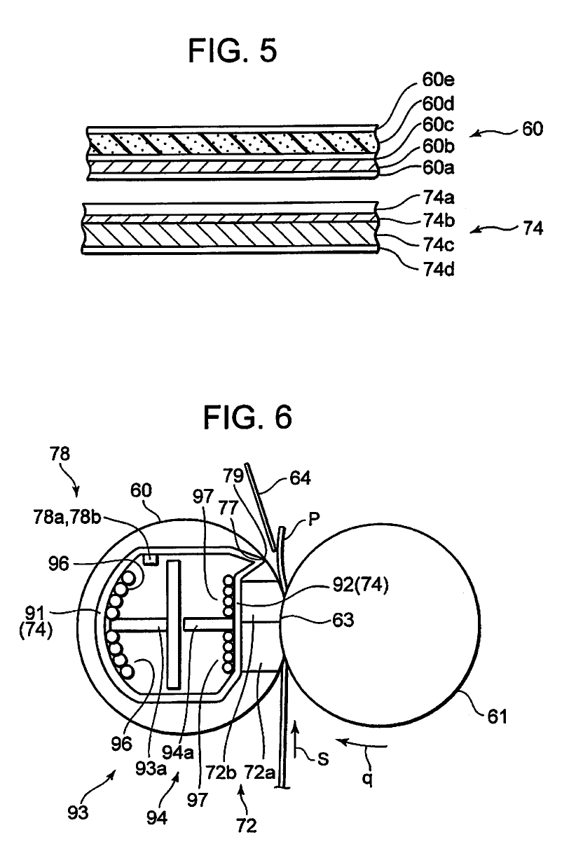

The fixing belt 60 has a multilayer structure. The fixing belt 60 has a heat generating layer 60b of nickel (Ni) with a thickness of 40 μm as a first metal heat generating layer, an adhesive layer 60c with a thickness of 20 μm, a silicone rubber layer 60d with a thickness of 200 μm, and a release layer 60e of fluorine resin with a thickness of 30 μm, around a supporting layer 60a, for example, as shown in FIG. 5. The material of the heat generating layer 60b may be stainless steel, aluminum, a composite material of stainless steel and aluminum, and the like. The heat generating layer 60b is inductively heated by an induced current generated by the IH coil 70. Flanges 62 support both sides of the fixing belt 60. The fixing belt 60 follows the press roller 61 and thus turns, integrally with the flanges 62.

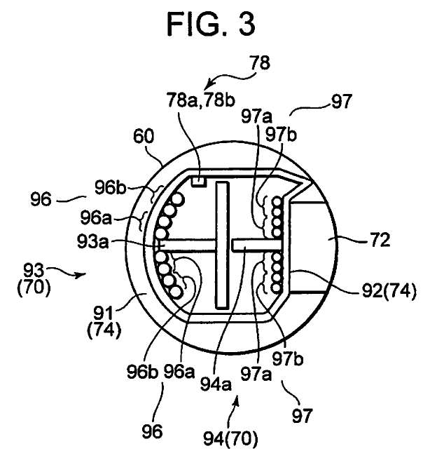

As shown in FIG. 3, the fixing unit 45 has the IH coil 70 and the auxiliary heat generating member 74 within the hollow part of the fixing belt 60. The auxiliary heat generating member 74 exists along an inner circumference of the fixing belt 60. The auxiliary heat generating member 74 has a first auxiliary heat generating part 91 along the inner circumference of the fixing belt 60, and a second auxiliary heat generating part 92 integrated with the pressurizing pad 72. The pressurizing pad 72 is located between the press roller 61 and the second auxiliary heat generating part 92. The second auxiliary heat generating part 92 tightly adheres to the pressurizing pad 72, for example, with an adhesive having good heat conductivity. The first auxiliary heat generating part 91 and the second auxiliary heat generating part 92 are continuous to each other.

The auxiliary heat generating member 74 has, from the inner circumferential side of the fixing belt 60, a release layer 74a of fluorine resin with a thickness of 15 μm, a second heat generating layer 74b as a second metal heat generating layer, a temperature equalizing layer 74c of aluminum with a thickness of 0.5 mm, and a protection layer 74d of white PFA resin with a thickness of 10 μm, for example, as shown in FIG. 5. The auxiliary heat generating member 74 keeps the temperature of the fixing belt 60 from its inner circumferential side and heats the pressurizing pad 72 from the inner circumferential side, thus preventing the temperature of the fixing belt 60 from falling.

The second heat generating layer 74b is inductively heated by an induced current generated by the IH coil 70. The second heat generating layer 74b generates an eddy-current because of magnetic fluxes from the IH coil 70. The second heat generating layer 74b generates heat using Joule heat based on the eddy-current and a resistance value of the second heat generating layer 74b. The second heat generating layer 74b includes a metal layer of, for example, nickel, stainless steel, aluminum or the like. Alternatively, the second heat generating layer 74b may use, for example, a magnetic shunt metal with a Curie point of 230° C., in order to prevent abnormal heat generation.

The thickness of the second heat generating layer 74b of the first auxiliary heat generating part 91 is, for example, 0.15 mm. The thickness of the second heat generating layer 74b of the second auxiliary heat generating part 92 is, for example, 0.15 mm. The second heat generating layer 74b of the first auxiliary heat generating part 91 is made thin to increase the induced current of the IH coil 70 which is transmitted to the fixing belt 60. It is also possible to increase the second heat generating layer 74b of the second auxiliary heat generating part 92 and thus increase the heat capacity of the second auxiliary heat generating part 92.

The temperature equalizing layer 74c equalizes the temperature of the auxiliary heat generating member 74 in a direction perpendicular to the traveling direction of the fixing belt 60. The temperature equalizing layer 74c uses a material with good heat conductivity, for example, copper or aluminum. Alternatively, an auxiliary heat generating member 76 may be formed using a functional material such as a heat pipe 76c as a temperature equalizing layer, as shown in FIG. 8.

The temperature equalizing layer 74c is provided in an area of the auxiliary heat generating member 74 where the heat generating layer 74b generates heats with the induced current of the IH coil 70. The temperature equalizing layer 74c equalizes the temperature of the auxiliary heat generating member 74 when the temperature difference between the center and sides of the auxiliary heat generating member 74 is increased. The temperature equalizing layer 74c is not effective when the temperature equalizing layer 74c is arranged outside of the area where the auxiliary heat generating member 74 generates heat with the induced current of the IH coil 70. The temperature equalizing layer 74c is provided only in the effective area, thus reducing the cost of the auxiliary heat generating member 74.

The protection layer 74d protects the temperature equalizing layer 74c and the heat generating layer 74b. The protection layer 74d has a heat reflection prevention function and protects the members arranged inside the fixing belt 60. The protection layer 74d prevents heat transfer to the members inside the fixing belt 60.

The auxiliary heat generating member 74 has a space of, for example, approximately 1 mm from the inner circumference of the fixing belt 60. Since the auxiliary heat generating member 74 has the space from the fixing belt 60, the auxiliary heat generating member 74 does not apply driving load to the fixing belt 60.

The auxiliary heat generating member 74 has a protrusion 77 which contacts the inner circumference of the fixing belt 60, in an area from the second auxiliary heat generating part 92 to the first auxiliary heat generating part 91 along the turning direction of the fixing belt 60 indicated by an arrow u. A distal end of the protrusion 77 has a curvature. The protrusion 77 contacts the inner circumference of the fixing belt 60 at a separation position 79 where a center of curvature of the distal end of the protrusion 77 faces a distal end of the separation blade 64.

As the protrusion 77 contacts the fixing belt 60, the auxiliary heat generating member 74 maintains a constant space between the fixing belt 60 and the distal end of the separation blade 64. The distal end of the separation blade 64 is brought closer to the fixing belt 60 while the space is maintained between the fixing belt 60 and the distal end of the separation blade 64. The separation blade 64, with its distal end brought close to the fixing belt 60, securely separates the sheet P having a narrow margin at its forward edge. Since the protrusion 77 has the release layer 74a on a surface, the influence of friction on the fixing belt 60 is reduced.

The IH coil 70 has a first IH 93 as a first induced current generating part, and a second IH 94 as a second induced current generating part. The first IH 93 faces the first auxiliary heat generating part 91. The second IH 94 adheres to the second auxiliary heat generating part 92. A supporting disk 71 fixes and supports the IH coil 70, the pressurizing pad 72 and the auxiliary heat generating member 74 inside the fixing belt 60. The first IH 93 generates magnetic fluxes mainly in the first auxiliary heat generating part 91 and the fixing belt 60. The second IH 94 generates magnetic fluxes mainly in the second auxiliary heat generating part 92.

As shown in FIG. 3, the first IH 93 has a first magnetic core 93a and a first coil 96. The first magnetic core 93a intensifies a magnetic field generated by the first coil 96. The first coil 96 has a first exciting coil 96a which generates magnetic fluxes across the entire length in the longitudinal direction of the fixing belt 60. The first coil 96 has a first degaussing coil 96b which has the opposite current direction to the current direction of the first exciting coil 96a and thus cancels the magnetic fluxes of the first exciting coil 96a, on both sides in the longitudinal direction of the fixing belt 60.

The second IH 94 has a second magnetic core 94a and a second coil 97. The second coil 97 is integrally provided on the second auxiliary heat generating part 92.

The second magnetic core 94a intensifies a magnetic field generated by the second coil 97. The second coil 97 has a second exciting coil 97a which generates magnetic fluxes across the entire length in the longitudinal direction of the fixing belt 60. The second coil 97 has a second degaussing coil 97b which has the opposite current direction to the current direction of the second exciting coil 97a and thus cancels the magnetic fluxes of the second exciting coil 97a, on both sides in the longitudinal direction of the fixing belt 60.

The first coil 96 and the second coil 97 use, for example, a Litz wire formed by bundling 100 copper wires each having a wire diameter of 0.2 mm and coated with heat-resistance polyamideimide, which is an insulating material. By using the Litz wire, it is possible to make the wire diameter smaller than a depth of penetration and thus allow an alternating current to flow effectively.

As a high-frequency current is applied to the first exciting coil 96a to generate magnetic fluxes, an eddy-current is generated in the first auxiliary heat generating part 91 and the heat generating layer 60b of the fixing belt 60. The eddy-current heats the first auxiliary heat generating part 91 and the fixing belt 60 across the entire length in the longitudinal direction. The first exciting coil 96a is excited to fix the sheet P having, for example, a width of JIS standard “A4” longitudinal size (297 mm).

When a high-frequency current is applied to the first exciting coil 96a and the first degaussing coil 96b, the first degaussing coil 96b cancels the magnetic fluxes of the first exciting coil 96a. The first exciting coil 96a and the first degaussing coil 96b are excited to fix the sheet P having, for example, a width of JIS standard “A4” lateral size (210 mm). The magnetic fluxes of the first IH 96 generate heat in the first auxiliary heat generating part 91 and the heat generating layer 60b of the fixing belt 60.

As a high-frequency current is applied to the second exciting coil 97a to generate magnetic fluxes, an eddy-current is generated in the second auxiliary heat generating part 92. The eddy-current heats the second auxiliary heat generating part 92 across the entire length in the longitudinal direction. The second exciting coil 97a is exited to heat the pressurizing pad 72 adhering to the second auxiliary heat generating part 92, across the entire length in the longitudinal direction.

When a high-frequency current is applied to the second exciting coil 97a and the second degaussing coil 97b, the second degaussing coil 97b cancels the magnetic fluxes of the second exciting coil 97a. The second exciting coil 97a and the second degaussing coil 97b are excited to heat a central area of the pressurizing pad 72 adhering to the second auxiliary heat generating part 92.

The auxiliary heat generating member 74 has a temperature sensor 78 on an inner circumference in the area where the heat generating layer 74b generates heat. The temperature sensor 78 has a first sensor 78a which detects the temperature at the center of the auxiliary heat generating member 74, and a second sensor 78b which detects the temperature on a side of the auxiliary heat generating member 74. The first sensor 78a and the second sensor 78b input results of detection to a main body control section 10 which controls the MFP 1.

The infrared temperature sensor 67 inputs a result of detection to the main body control section 10. The main body control section 10 has an IH control portion 10a which controls the application of a high-frequency current to the IH coil 70, and a drive control portion 10b which controls the pressure adjustment or rotational driving of the press roller 61. The IH control portion 10a integrally controls the first IH 93 and the second IH 94 of the IH coil 70. The IH control portion 10a applies a high-frequency current simultaneously to the first exciting coil 96a of the first coil 96 and the second exciting coil 97a of the second coil 97. The IH control portion 10a applies a high-frequency current simultaneously to the first degaussing coil 96b of the first coil 96 and the second degaussing coil 97b of the second coil 97.

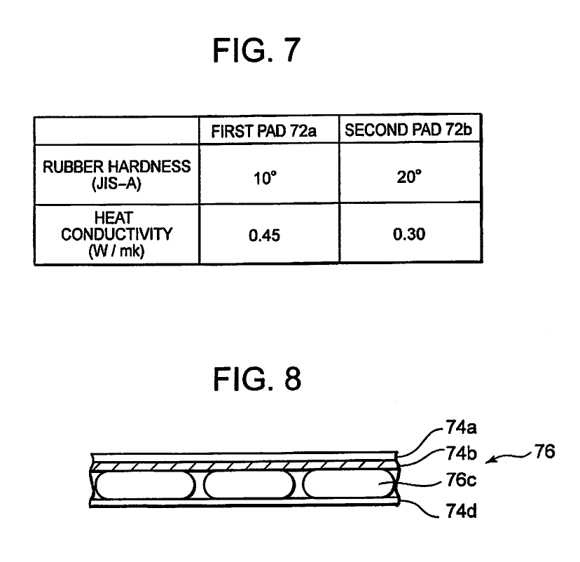

The pressurizing pad 72 is made of, for example, a heat-resistant silicone sponge or silicone rubber, and has a release layer of, for example, a fluorine resin, on its surface. The pressurizing pad 72 has a first pad 72a and a second pad 72b having different material properties, for example, as shown in FIG. 6 and FIG. 7.

The first pad 72a, which is upstream in the carrying direction of the sheet P indicated by an arrow s on the pressurizing pad 72, has material properties including a JIS standard rubber hardness (JIS-A) of 10 degrees and a heat conductivity (W/mK) of 0.45. The second pad 72b on the downstream side has a JIS standard rubber hardness (JIS-A) of 20 degrees and a heat conductivity (W/mK) of 0.30. The first pad 72a on the upstream side has a greater rubber hardness and a lower heat conductivity than the second pad 72b on the downstream side.

The press roller 61 has, for example, a heat-resistant silicone sponge or silicone rubber layer around a core metal and has a PFA release layer on its surface. A press roller frame 80 supporting the press roller 61 has a fulcrum 80a. The press roller frame 80 rotates about the fulcrum 80a in relation to a fixing belt frame 90 supporting the fixing belt 60. The press roller 61 has a pressure change mechanism 87 which adjusts a pressurizing force of the press roller 61 to the pressurizing pad 72. The pressure change mechanism 87 has a cam 81, a bearing 82, and a pressurizing spring 85. The pressurizing spring 85 pressurizes the press roller 61 in the direction of an arrow r.

The cam 81 is elliptic and has a cam surface 83a far from a center of rotation 81a and a cam surface 83b close to the center of rotation 81a. When the cam surface 83b close to the center of rotation 81a of the cam 81 contacts the bearing 82, the pressure in the nip 63 is high. The cam surface 83a far from the center of rotation 81a of the cam 81 contacts the bearing 82, the press roller frame 80 rotates in the direction of an arrow t against the force of the pressurizing spring 85 in the direction of the arrow r.

When the fixing unit 45 is used, the cam surface 83b close to the center of rotation 81a of the cam 81 contacts the bearing 82, and the pressurizing spring 85 pressurizes the press roller 61 to the pressurizing pad 72 with a high pressure. When the fixing unit 45 is not used, the cam surface 83a far from the center of rotation 81a of the cam 81 contacts the bearing 82. The press roller frame 80 rotates in the direction of the arrow t and the pressure of the press roller 61 to the pressurizing pad 72 is reduced, thus prevent permanent strain of the press roller 61.

The press roller frame 80 fixes and supports the separation blade 64. When the fixing unit 45 is used, the separation blade 64 faces the fixing belt 60 laid along the pressurizing pad 72 pressed by the high pressure of the press roller 61. When the pressure of the press roller 61 to the pressurizing pad 72 is reduced while the fixing unit 45 is not used, the pressed pressurizing pad 72 recovers. When the pressurizing pad 72 recovers, the separation blade 64 is rotated in the direction of the arrow t by the press roller frame 80 and moves away from the pressurizing pad 72. When the recovering of the pressurizing pad 72 is complete, the distal end of the separation blade 64 does not contact the fixing belt 60. At the time of separation, the distal end of the separation blade 64 can move closer to the fixing belt 60 in order to securely separate the sheet P. At the time of separation, the distal end of the separation blade 64 maintains a space of, for example, 0.1 to 0.4 mm, to the fixing belt 60.

When print is started, the drive control portion 10b rotationally controls the cam 81 of the fixing unit 45 and causes the cam surface 83b close to the center of rotation 81a of the cam 81 to contact the bearing 82. The press roller frame 80 is rotated in the direction of the arrow r by the spring force of the pressurizing spring 85. The press roller 61 pressurizes the pressurizing pad 72 with a high pressure. The separation blade 64 supported on the press roller frame 80 rotates in the direction of the arrow r and has its distal end located at the separation position. The drive control portion 10b rotates the press roller 61 in the direction of an arrow q and causes the fixing belt 60 to follow the press roller 61 and thus turn in the direction of the arrow u.

When the fixing belt 60 follows and turns, the auxiliary heat generating member 74 is away from the inner circumference of the fixing belt 60, except the protrusion 77. No driving load due to the contact with the auxiliary heat generating member 74 occurs on the fixing belt 60. The fixing belt 60 is stably driven to turn.

The IH control portion 10a applies a high-frequency current to the first coil 96 and the second coil 97 according to the size of the sheet P. The IH control portion 10a simultaneously performs feedback control of the first IH 93 and the second IH 94 based on the result of detection from the infrared temperature sensor 67 and maintains the fixing belt 60 at a fixing temperature. The magnetic fluxes of the first coil 96 heat the first auxiliary heat generating part 91 and the fixing belt 60. The magnetic fluxes of the second coil 97 heat the second auxiliary heat generating part 92.

The heat of the first auxiliary heat generating part 91 is conducted to the fixing belt 60 via the space and prevents temperature fall in the fixing belt 60. The heat of the second auxiliary heat generating part 92 is conducted to the pressurizing pad 72 via the adhesive and heats the pressurizing pad 72. The pressurizing pad 72 heats the fixing belt 60 from the inner circumference at the position of the nip 63 and maintains the temperature of the fixing belt 60.

At the time of fixing, the fixing belt 60 is deprived of its heat by the sheet. For example, at the time of fixing a thick paper, the fixing belt 60 is deprived of a large quantity of heat. When the thick paper is fixed, simply heating with the IH coil the fixing belt 60 in the area where the sheet P passes may result in the recovery temperature of the fixing belt 60 that varies from cycle to cycle. When the recovery temperature of the fixing belt 60 varies from cycle to cycle, the temperature variance of the fixing belt 60 by the cycle appears in the form of gloss variance in the fixed image. The second auxiliary heat generating part 92 heats the pressurizing pad 72 to heat the fixing belt 60 in an auxiliary manner. The fixing belt 60 is heated in an auxiliary manner by the pressurizing pad 72 and the gloss variance by the cycle of the fixing belt 60 appears in the fixed image is prevented.

The sheet P passing the nip 63 in the direction of the arrow s tightly contacts the fixing belt 60 in the area of the first pad 72a having a low rubber hardness and a high heat conductivity. The fixing belt 60 sufficiently heats the toner image on the sheet P and thus enhances fixability. The sheet P is easily separated from the fixing belt 60 in the area of the second pad 72b having a high rubber hardness and a low heat conductivity. The cooling time of the toner image on the sheet P after being separated from the fixing belt 60 is shortened. As the cooling time of the melted toner image is short at the time of fixing, the gloss of the fixed image is improved.

The fixing belt 60 loses heat by the passage of the sheet P. However, the first auxiliary heat generating part 91 maintains the temperature of the fixing belt 60 from the inner circumference. The second auxiliary heat generating part 92 heats the pressurizing pad 72 and thus heats the fixing belt 60 from the inner circumference.

As the forward edge of the sheet P passing in the arrow s direction exits the nip 63, the distal end of the separation blade 64 separates the forward edge of the sheet P from the fixing belt 60. The protrusion 77 of the auxiliary heat generating member 74 contacts the fixing belt 60 at the position facing the distal end of the separation blade 64. The distal end of the separation blade 64 is now closer to the fixing belt 60 and can easily maintain the space from the fixing belt 60. The separation blade 64 securely separates the sheet P having a narrow margin at the forward edge of the image. After the sheet P is separated, the fixing belt 60 is heated again by the first IH 93 while having its temperature maintained by the first auxiliary heat generating part 91.

When the temperature on the side of the first auxiliary heat generating part 91 of the fixing unit 45 is raised during the fixing, the IH control portion 10a controls the operation. For example, when small-size sheets P are continuously passed, the IH control portion 10a applies a high-frequency current simultaneously to the first degaussing coil 96b of the first coil 96 and the second degaussing coil 97b of the second coil 97 and thus cancels the heat generation on both sides of the fixing belt 60. Also, the auxiliary heat generating member 74 has the temperature equalizing layer 74c to equalize the temperature at the center and the sides of the auxiliary heat generating member 74.

When print is finished, the drive control portion 10b rotationally controls the cam 81 of the fixing unit 45 and causes the cam surface 83a far from the center of rotation 81a of the cam 81 to contact the bearing 82. The press roller frame 80 rotates in the direction of the arrow t against the spring force of the pressurizing spring 85. The pressure of the press roller 61 to the pressurizing pad 72 is reduced. The pressed pressurizing pad 72 recovers and the separation blade 64 is moved away from the fixing belt 60 by the press roller frame 80.

At the time of fixing, the distal end of the separation blade 64 comes closer to the fixing belt 60 and securely separates the sheet P. After the end of the fixing, the distal end of the separation blade 64 securely moves away from the fixing belt 60.

According to the first embodiment, the magnetic fluxes generated by the first IH 93 generate heat in the first auxiliary heat generating part 91 of the auxiliary heat generating member 74 and the fixing belt 60. The first auxiliary heat generating part 91, which generates heat, maintains the temperature of the fixing belt 60. The magnetic fluxes generated by the second IH 94 generate heat in the second auxiliary heat generating part 92 of the auxiliary heat generating member 74. The second auxiliary heat generating part 92, which generates heat, heats the pressurizing pad 72 and the fixing belt 60 contacting the pressurizing pad 72. The auxiliary heat generating member 74 increases the quantity of heat provided for the fixing belt 60. The temperature variance by the cycle of the fixing belt 60 is prevented and the gloss variance occurring in the fixed image is prevented.

The auxiliary heat generating member 74 applies no driving load on the fixing belt 60 because the auxiliary heat generating member 74 has a space from the fixing belt 60. The fixing belt 60 turns stably. The protrusion 77 of the auxiliary heat generating member 74 contacts the fixing belt 60 at the position facing the distal end of the separation blade 64, and a constant space is maintained between the fixing belt 60 and the distal end of the separation blade 64. Since the space between the fixing belt 60 and the distal end of the separation blade 64 is maintained, the distal end of the separation blade 64 can be brought closer to the fixing belt 60 and separates the sheet P securely.

According to the first embodiment, the first pad 72a upstream in the carrying direction of the sheet P has a low rubber hardness and a high heat conductivity. The second pad 72b downstream in the carrying direction of the sheet P has a high rubber hardness and a low heat conductivity. The pressurizing pad 72 enhances the fixability of the toner image on the sheet P, enhances the separability of the sheet P from the fixing belt 60, and improves the gloss of the fixed image.

### Second Embodiment

A second embodiment is different from the first embodiment in the structure of the auxiliary heat generating member. In the second embodiment, the same components of the configuration as described in the first embodiment are denoted by the same reference numerals and will not be described further in detail.

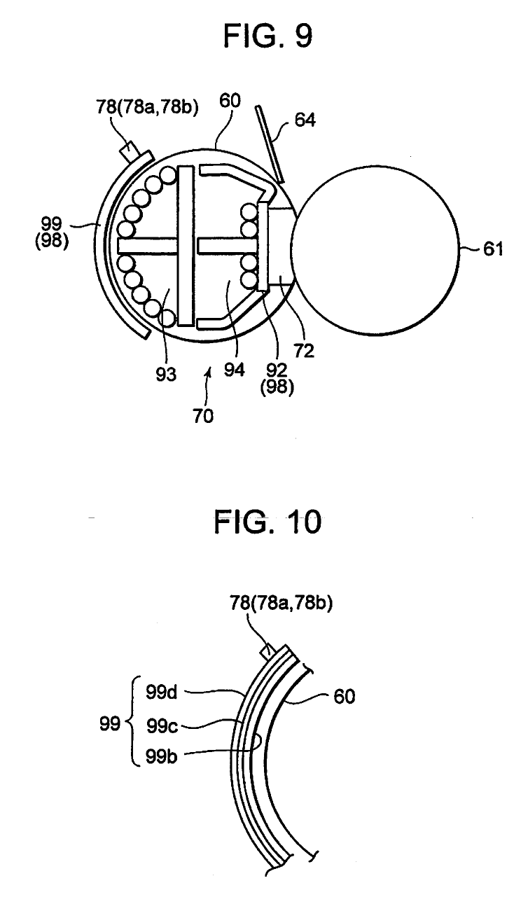

As shown in FIG. 9, an auxiliary heat generating member 98 of the fixing unit 45 has a third auxiliary heat generating part 99 exists along the outer circumference of the fixing belt 60 at a space of, for example, approximately 1 mm, from the fixing belt 60, and the second auxiliary heat generating part 92 attached to the pressurizing pad 72. As shown in FIG. 10, the third auxiliary heat generating part 99 has, from the side closer to the fixing belt 60, a third heat generating layer 99b having, for example, a thickness of 0.15 mm as a second metal heat generating layer, a temperature equalizing layer 99c with a thickness of 0.5 mm, and a protection layer 99d of a white PFA resin with a thickness of 10 μm. The third heat generating layer 99b generates heat with an induced current of the first IH 93 transmitted through the fixing belt 60. With the heat generation of the third heat generating layer 99b, the third auxiliary heat generating part 99 maintains the temperature of the fixing belt 60 from the outside and prevents temperature fall in the fixing belt 60.

The third auxiliary heat generating part 99 has, on the side of the protection layer 99d, the first sensor 78a which detects the temperature at the center of the third auxiliary heat generating part 99, and the second sensor 78b which detects the temperature on a side of the third auxiliary heat generating part 99.

When the fixing belt 60 follows and turns as print is started, the IH control portion 10a simultaneously performs feedback control of the first IH 93 and the second IH 94 and maintains the fixing belt 60 at a fixing temperature. The magnetic fluxes of the first coil 96 heat the fixing belt 60 and the third auxiliary heat generating part 99. The heat of the third auxiliary heat generating part 99 is conducted to the fixing belt 60 via the space and prevents temperature fall in the fixing belt 60.

According to the second embodiment, the magnetic fluxes generated by the first IH 93 generates heat in the fixing belt 60 and the third auxiliary heat generating part 99 of the auxiliary heat generating member 98. The third auxiliary heat generating part 99, which generates heat, maintains the temperature of the fixing belt 60. The magnetic fluxes generated by the second IH 94 generate heat in the second auxiliary heat generating part 92 of the auxiliary heat generating member 98. The second auxiliary heat generating part 92, which generates heat, heats the pressurizing pad 72 and the fixing belt 60 contacting the pressurizing pad 72. The auxiliary heat generating member 98 increases the quantity of heat provided for the fixing belt 60. The temperature variance by the cycle of the fixing belt 60 is prevented and the gloss variance occurring in the fixed image is prevented.

According to the fixing device of one of the embodiments, heat is generated in the auxiliary heat generating member together with the fixing belt. The quantity of heat provided for the fixing belt is increased and the gloss variance occurring in the fixed image is prevented.

While certain embodiments have been described these embodiments have been presented by way of example only, and are not intended to limit the scope of the inventions. Indeed, the novel apparatus and methods described herein may be embodied in a variety of other forms: furthermore various omissions, substitutions and changes in the form of the apparatus and methods described herein may be made without departing from the spirit of the inventions. The accompanying claims and their equivalents are intended to cover such forms of modifications as would fall within the scope and spirit of the invention.

What is claimed is:

1. A fixing device comprising:
a fixing belt comprising a first metal heat generating layer;
a pressurizing unit which faces an outer circumference of the fixing belt;
an induced current generating coil located within a hollow part of the fixing belt;
a nip forming member which pressurizes the fixing belt to the pressurizing unit; and
an auxiliary heat generating member located in a periphery of the fixing belt and comprising a second metal heat generating layer.

2. The device of claim 1, wherein the nip forming member is integrated with the induced current generating coil.

3. The device of claim 1, wherein the auxiliary heat generating member comprises a first auxiliary heat generating part along the fixing belt, and a second auxiliary heat generating part connecting to the nip forming member.

4. The device of claim 3, wherein the first auxiliary heat generating part is located outside of the fixing belt.

5. The device of claim 3, wherein the first auxiliary heat generating part is located within the hollow part of the fixing belt.

6. The device of claim 5, wherein the first auxiliary heat generating part and the second auxiliary heat generating part are continuous to each other.

7. The device of claim 5, wherein the second auxiliary heat generating part is situated more closely to the pressurizing unit side than the first auxiliary heat generating part.

8. The device of claim 5, wherein the nip forming member is integrated with the induced current generating coil.

9. The device of claim 8, wherein the nip forming member is located between the second auxiliary heat generating part and the pressurizing unit.

10. The device of claim 1, wherein the second metal heat generating layer comprises a magnetic layer.

11. An image forming apparatus comprising:
an image forming unit which forms an image on a recording medium;
a fixing belt comprising a first metal heat generating layer;
a pressurizing unit which nips the recording medium between the pressurizing unit and the fixing belt and carries the recording medium;
an induced current generating coil located within a hollow part of the fixing belt;
a nip forming member which pressurizes the fixing belt to the pressurizing unit; and
an auxiliary heat generating member located in a periphery of the fixing belt and comprising a second metal heat generating layer.

12. The apparatus of claim 11, wherein the nip forming member is integrated with the induced current generating coil.

13. The apparatus of claim 11, wherein the auxiliary heat generating member comprises a first auxiliary heat generating part along the fixing belt, and a second auxiliary heat generating part connecting to the nip forming member.

14. The apparatus of claim 13, wherein the first auxiliary heat generating part is located outside of the fixing belt.

15. The apparatus of claim 14, wherein the first auxiliary heat generating part is located within the hollow part of the fixing belt, and the induced current generating coil heats the fixing belt with a magnetic flux transmitted through the first auxiliary heat generating part.

16. The apparatus of claim 11, wherein the second metal heat generating layer has a magnetic layer.

17. A fixing method comprising:
generating an induced current within the hollow part of the fixing belt in a state where, the fixing belt is pressurized toward a pressurizing unit from within a hollow part of a fixing belt, by a nip forming member; and
heating the fixing belt, an auxiliary heat generating member located in a periphery of the fixing belt, and the nip forming member with the induced current.

18. The method of claim 17, wherein the auxiliary heat generating member comprises, in the hollow part, a second auxiliary heat generating part connecting to the nip forming member, and heats the fixing belt with a magnetic flux transmitted through the second auxiliary heat generating part.
